(19) United States
(12) Patent Application Publication
(10) Pub. No.: US 2012/0154968 A1
(43) Pub. Date: Jun. 21, 2012

(54) OVERLOAD PROTECTION DEVICE

(76) Inventor: Darak Chen, Tainan County (TW)

(21) Appl. No.: 12/974,082

(22) Filed: Dec. 21, 2010

(51) Int. Cl. H02H 3/20

(52) U.S. Cl. 361/91.1

(57) ABSTRACT

An overload protection device includes a power detection unit, a processing unit, a breaker unit and a warning unit. According to the power value detected by the power detection unit, the processing unit determines whether to drive the breaker unit and determines the warning level of the warning unit. Accordingly, the overload protection device can provide overload protection and achieve warning effect.

### FIELD OF THE INVENTION

The present invention relates generally to an overload protection device, and more particularly to an overload protection device with warning function.

### BACKGROUND OF THE INVENTION

In order to avoid danger caused by fusion of electrical wire under too high electrical power, a domestic general power switch is often equipped with a fuse. The fuse has a melting point lower than that of the electrical wire (copper wire). Therefore, in case of an overload, the fuse will fuse first under high heat to interrupt power supply and thus avoid short-circuit. However, once the fuse fuses, it is necessary to replace it with a new one. This is quite inconvenient to the resident. Therefore, most of the current general power switches are already provided with spring switches instead of the fuses. The spring switch works in the principle that in case of overload, the spring switch will automatically bound up to break the power supply circuit. When it is desired to recover the power supply, it is necessary to shift the spring switch back to its home position. Such design is able to avoid danger of short-circuit caused by overload. However, after a period of use, elastic fatigue of the spring switch is likely to take place. In this case, a serious consequence may happen. Therefore, the above overload protection switch can hardly reliably provide an overload protection effect. Moreover, the resident cannot be aware of whether the current power supply is safe, close to an overload state or already in an overload state. In this case, the power supply will continue. This may lead to a dangerous situation.

### SUMMARY OF THE INVENTION

It is therefore a primary object of the present invention to provide an overload protection device with warning effect.

According to the above and other objects, the overload protection device of the present invention includes: a power detection unit for detecting the value of power output by an external power supply; a processing unit electrically coupled with the power detection unit and preset with a power limitation value; a breaker unit electrically coupled with the processing unit; and a warning unit electrically coupled with the processing unit. In the case the value of the power is smaller than the power limitation value, the processing unit controls the warning unit to generate a first warning signal. In the case the value of the power is larger than the power limitation value, the processing unit controls the warning unit to generate a second warning signal and activate the breaker unit to interrupt power supply from the external power supply.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a block diagram showing the layout of the overload protection device of the present invention; and

FIG. 2 is a block diagram of the overload protection device of the present invention.

### DETAILED DESCRIPTION OF THE PREFERRED EMBODIMENTS

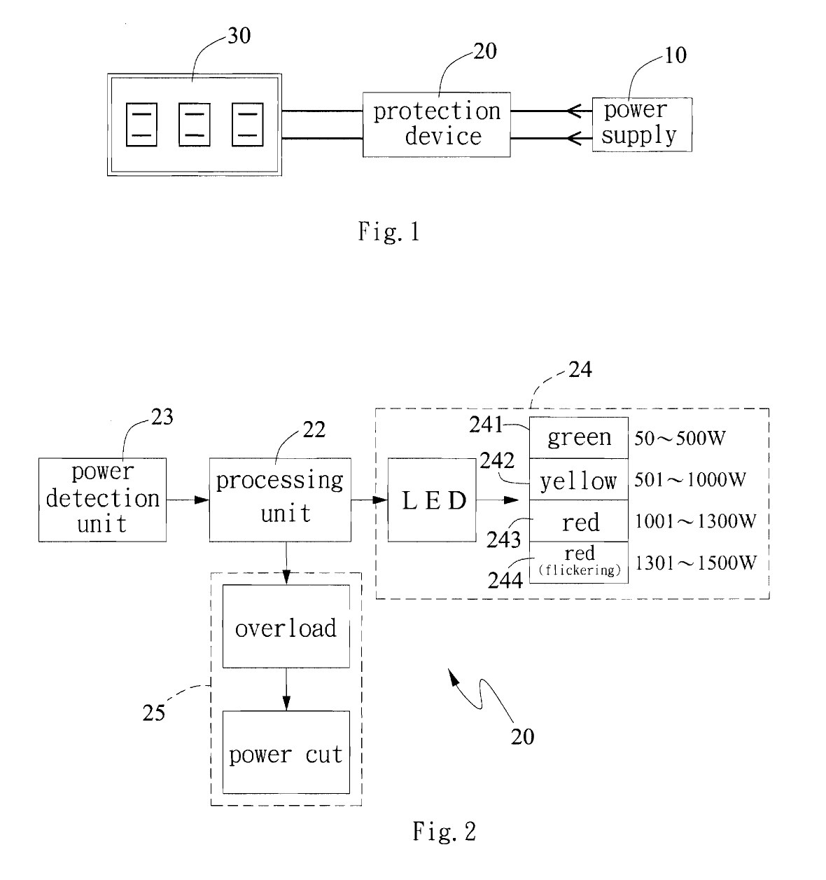

Please refer to FIGS. 1 and 2. FIG. 1 is a block diagram showing the layout of the overload protection device of the present invention. FIG. 2 is a block diagram of the overload protection device of the present invention. The overload protection device 20 of the present invention is arranged between an external power supply (civil power) 10 and a wall socket 30 or a socket of an extension cable. The overload protection device 20 mainly includes a power detection unit 23, a processing unit 22, a breaker unit 25 and a warning unit 24. According to the power value detected by the power detection unit 23, the processing unit 22 determines whether to drive the breaker unit 25 and determines the warning level of the warning unit 24.

For example, the power detection unit 10 is electrically coupled with the external power supply (civil power) 10 to detect the value of the power output by the external power supply 10. The processing unit 22 is electrically coupled with the power detection unit 23 and preset with a power limitation value (such as 1500 watts). The warning unit 24 and the breaker unit 25 are both electrically coupled with the processing unit 22. The warning unit 24 is a light-emitting diode (LED) or a loud speaker. In the case the power detection unit 23 detects that the value of the power output by the external power supply (civil power) 10 is smaller than the power limitation value, the processing unit 22 will control the warning unit 24 to generate a first warning signal (such as to make the LED unlighted or simply flicker once or make the loud speaker silenced or simply beep once). In the case the value of the power is larger than the power limitation value (1500 watts), the processing unit 22 will control the warning unit 24 to generate a second warning signal (such as to make the LED continuously flicker or make the loud speaker continuously beep). In the meantime, the breaker unit 25 is activated to interrupt power supply from the external power supply 10. Accordingly, when the power is cut off, a user can know from the warning unit 24 why the power is cut off. The user can judge whether it is the case of a blackout or an overload and then make a proper management.

In addition, the overload protection device 20 of the present invention has a better warning function. The warning unit 24 further includes a first indicator lamp 241, a second indicator lamp 242, a third indicator lamp 243 and a fourth indicator lamp 244. Also, the power limitation value is correspondingly classified into first to fourth power levels (500 W, 1000 W, 1300 W, 1500 W). In the case the value of the power output by the external power supply (civil power) 10 is smaller than the first power level (500 W), the processing unit 22 drives the first indicator lamp 241 of the warning unit 24 to emit such as green light to show that the current power supply is quite safe. In the case the value of the power output by the external power supply (civil power) 10 is between the first power level (500 W) and the second power level (1000 W), the processing unit 22 drives the second indicator lamp 242 of the warning unit 24 to emit such as yellow light to show that the current power supply is slightly higher but still within a safety range. In the case the value of the power output by the external power supply (civil power) 10 is between the second power level (1000 W) and the third power level (1300 W), the processing unit 22 drives the third indicator lamp 243 of the warning unit 24 to emit such as red light to show that the current power supply is too high and no further load should be added. In the case the value of the power output by the external power supply (civil power) 10 is larger than the fourth power level (1500 W), the processing unit 22 drives the fourth indicator lamp 244 of the warning unit 24 to emit such as red light in a flickering manner to show that the current power supply is overloaded and the power from the external power supply 10 is cut off. Accordingly, a resident or a user can judge the current power supply from the external power supply 10 for the loads by means of the warning unit 24 and consider how to adjust the number of the loads.

The above embodiments are only used to illustrate the present invention, not intended to limit the scope thereof. It is understood that many changes and modifications of the above embodiments can be made without departing from the spirit of the present invention. The scope of the present invention is limited only by the appended claims.

What is claimed is:

1. An overload protection device comprising:
a power detection unit for detecting the value of power output by an external power supply;
a processing unit electrically coupled with the power detection unit and preset with a power limitation value;
a breaker unit electrically coupled with the processing unit; and
a warning unit electrically coupled with the processing unit, in the case the value of the power is smaller than the power limitation value, the processing unit controlling the warning unit to generate a first warning signal, in the case the value of the power is larger than the power limitation value, the processing unit controlling the warning unit to generate a second warning signal and activating the breaker unit to interrupt power supply from the external power supply.

2. The overload protection device as claimed in claim 1, wherein the warning unit is a light-emitting diode.

3. The overload protection device as claimed in claim 1, wherein the warning unit is a loud speaker.

4. The overload protection device as claimed in claim 1, wherein the power limitation value is classified into a first power level, a second power level, a third power level and a fourth power level, the warning unit including a first indicator lamp, a second indicator lamp, a third indicator lamp and a fourth indicator lamp, in the case the value of the power is smaller than the first power level, the processing unit driving the first indicator lamp to emit light, in the case the value of the power is between the first power level and the second power level, the processing unit driving the second indicator lamp to emit light, in the case the value of the power is between the second power level and the third power level, the processing unit driving the third indicator lamp to emit light, in the case the value of the power is larger than the fourth power level, the processing unit driving the fourth indicator lamp to emit light and the power from the external power supply being cut off.
